(19) United States
(12) Patent Application Publication
(10) Pub. No.: US 2003/0202010 A1
(43) Pub. Date: Oct. 30, 2003

(54) Retention of job settings based on data type

(76) Inventors: George H. Kerby, Boise, ID (US); Roger Scott Twede, Meridian, ID (US); John C. Cannon, Boise, ID (US); Travis J. Parry, Boise, ID (US)

Correspondence Address: HEWLETT-PACKARD COMPANY, Intellectual Property Administration, P.O. Box 272400, Fort Collins, CO, 80527-2400, US

(21) Appl. No.: 10/132,945

(22) Filed: Apr. 26, 2002

(51) Int. Cl. G09G 5/00

(52) U.S. Cl. 345/744

(57) ABSTRACT

Systems for retaining print job settings based upon a user's preferred print settings including a processor adapted to communicate with an imaging device and a registry coupled to the imaging device that includes the user's preferred print setting. In one embodiment, the registry stores the user's print settings in a database as name/value pairs. The user's print settings in the registry can override any default settings stored in the registry. Likewise, if print settings accompany a print job, those settings can override the user's preferred print setting stored in the registry. Systems and other methods also are provided.

### TECHNICAL FIELD

The present invention is generally related to imaging systems and, more particularly, is related to a system and method for retaining job settings.

### BACKGROUND OF THE INVENTION

In today's environment, access to computers is fairly widespread and is frequently utilized. A variety of applications are available for use on a computer. For instance, common applications include word processing, electronic mail, spreadsheets, presentations, computer aided drawings (CADs), and documents available through the Internet. Users can print these various documents in a number of formats. For example, print formats available to users include selecting the print media, such as paper or transparency, paper size, page setup, duplex or simplex printing, and the number of copies.

While the number of printing options to a user is wide, many users typically print the same type of document using the same printer setting. For instance, a user may frequently print presentations on transparencies on one side of the transparency, and electronic mail documents on letter sized paper on both sides of the paper. The other available print options may be virtually ignored by this user. However, each time the user changes the type of document printed, i.e., from presentation to electronic mail document, the user must manually intervene, and specify the print settings for use with the particular print job. Thus, each time a different type of document is printed, the user must specify and communicate to the printer the print settings, such as paper type and page setup.

Thus, a heretofore unaddressed need exists for a solution that addresses the aforementioned deficiencies and inadequacies.

### SUMMARY OF THE INVENTION

The present invention provides a system and method for the retention of job settings.

One embodiment of the system, among others, can be implemented as follows. A system for printing a print job based upon a user's preference comprises a processor adapted to communicate with an imaging device and a registry coupled to the imaging device and accessible to the processor. The registry includes print settings for printing an image based upon a data format and at least one user's preferred print setting.

The present invention can also be viewed as providing methods for printing a print job request based upon a user's preferences stored in a registry. In this regard, one embodiment of such a method, among others, includes the following steps: associating user print settings with a data format, receiving a print request, accessing the user print settings, and printing the request according to the user print settings.

Other systems, methods, and features of the present invention will be or become apparent to one with skill in the art upon examination of the following drawings and detailed description. It is intended that all such additional systems, methods, and features be included within this description, be within the scope of the present invention, and be protected by the accompanying claims.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a block diagram depicting an embodiment of an environment in which a job setting retention system may be implemented.

FIG. 2 is a block diagram depicting a processor-based system that can be used to implement an embodiment of job setting retention system.

FIG. 3 is a block diagram depicting an embodiment of modules of the job setting retention system shown in FIG. 2.

FIG. 4 is a table depicting an embodiment of a print registry shown in FIG. 3.

FIG. 5 is a flow chart depicting functionality of an embodiment of the job setting retention system of FIG. 2.

FIG. 6 is a flow chart depicting an embodiment of obtaining the print job settings of the method of FIG. 5.

### DETAILED DESCRIPTION

Described below is one embodiment of a job setting retention system having internal registries that provides for retaining job settings. To facilitate description of the system, an example device that can be used to implement the job setting retention system is discussed with reference to the figures. Although this system is described in detail, it will be appreciated that this system is provided for purposes of illustration only and that various modifications are feasible without departing from the inventive concept. After the example system has been described, an example of operation of the device will be provided to explain the manner in which the system can be used to provide job setting retention.

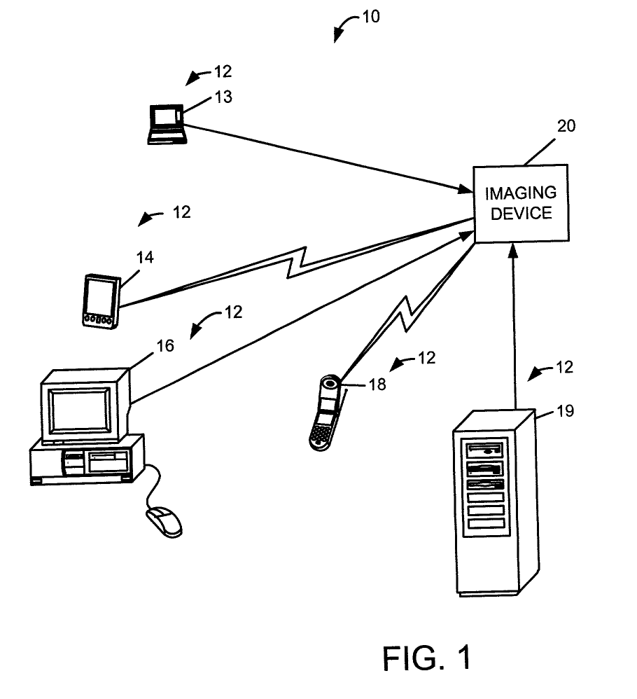

Referring now in more detail to the drawings, in which like numerals indicate corresponding parts throughout the several views, FIG. 1 is a block diagram depicting an embodiment of an environment 10 in which a job setting retention system may be implemented. The environment 10 can include a plurality of devices, such as computing devices 12, for instance, a laptop computer 13, a personal data assistant (PDA) 14, a personal computer 16, a mobile telephone 18, and a server 19. The computing devices 12 are operatively coupled to an imaging device 20. In one embodiment, the imaging device comprises a printer. In other embodiments, the imaging device 20 comprises multifunction peripherals, all-in-one machines that can print, copy, scan and fax, or display devices such as digital projectors. Print job requests can occur between the plurality of computing devices 12, and the imaging device 20.

The environment 10 in which the job setting retention system may be implement includes a registry for retaining job settings for various file formats. In one embodiment, the registry stores the user's print settings in a database as name/value pairs. A user, system administrator, or default settings resident in the imaging device 20 can establish the job settings. A user can establish print job settings for a plurality of file formats, such as, word processing documents, spreadsheet files and electronic mail messages. For each file format, the user can select print settings, for instance, paper size and type, fonts, and print page setup. The registry includes the setting for each user who accesses the imaging device 20.

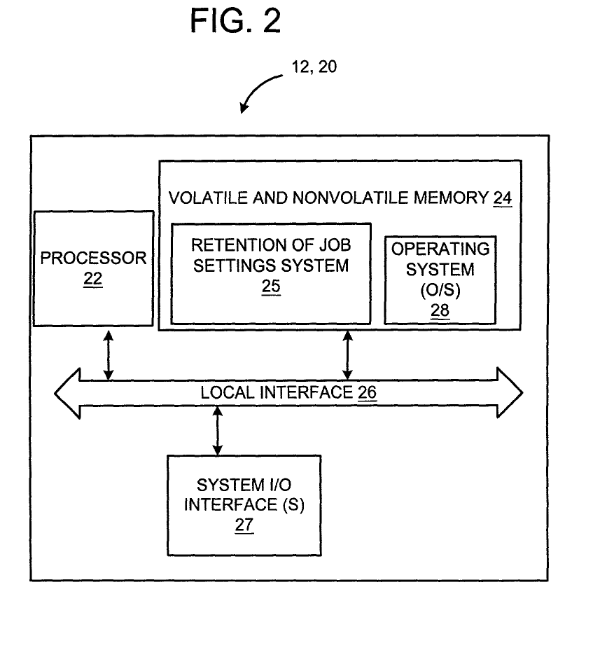

The environment 10 can be implemented in software, firmware, hardware, or a combination thereof. In the currently contemplated best mode, the environment 10 is implemented in software as an executable program, and is executed by a special or general purpose digital computer, such as a personal computer (PC; IBM-compatible, Apple-compatible, or otherwise), workstation, minicomputer, or mainframe computer. An example of a general purpose computer that can implement the job setting retention system of the present invention is shown in FIG. 2.

Generally, in terms of hardware architecture, as shown in FIG. 2, the digital computer can comprise the computing devices 12 and/or the imaging device 20, and includes, a processor 22 and memory 24. Input and/or output (I/O) devices, such as devices 12, 14, 16, 18 and 19 (or peripherals) can be communicatively coupled to a local interface 26 via a system I/O interface 27, or directly connected to the local interface 26. The local interface 26 can be, for example but not limited to, one or more buses or other wired or wireless connections, as is known in the art. The local interface 26 may have additional elements, which are omitted for simplicity, such as controllers, buffers (caches), drivers, repeaters, and receivers, to enable communications. Further, the local interface may include address, control, and/or data connections to enable appropriate communications among the aforementioned components.

The processor 22 is a hardware device for executing software or firmware, particularly that stored in memory 24. The processor 22 can be any custom made or commercially available processor, a central processing unit (CPU), an auxiliary processor among several processors associated with the computing devices 12, a semiconductor based microprocessor (in the form of a microchip or chip set), a macroprocessor, or generally any device for executing software instructions.

The memory 24 can include any one or combination of volatile memory elements (e.g., random access memory (RAM, such as DRAM, SRAM, SDRAM, etc.)) and nonvolatile memory elements (e.g., ROM, hard drive, tape, CDROM, etc.). Moreover, the memory 24 may incorporate electronic, magnetic, optical, and/or other types of storage media. Note that the memory 24 can have a distributed architecture, where various components are situated remote from one another, but can be accessed by the processor 22.

The software and/or firmware in memory 24 may include one or more separate programs, each of which comprises an ordered listing of executable instructions for implementing logical functions. In the example of FIG. 2, the software in the memory 24 includes a job setting retention system 25 and a suitable operating system (O/S) 28. The operating system 28 essentially controls the execution of other computer programs, such as the job setting retention system 25, and provides scheduling, input-output control, file and data management, memory management, and communication control and related services.

The job setting retention system 25 is a source program, executable program (object code), script, or any other entity comprising a set of instructions to be performed. When the job setting retention system 25 is implemented as a source program, then the program needs to be translated via a compiler, assembler, interpreter, or the like, which may or may not be included within the memory 24, so as to operate properly in connection with the O/S 28. Furthermore, the job setting retention system 25 can be written as (a) an object oriented programming language, which has classes of data and methods, or (b) a procedure programming language, which has routines, subroutines, and/or functions, for example but not limited to, C, C++, Pascal, Basic, Fortran, Cobol, Perl, Java, and Ada.

The I/O devices may include input devices, for example but not limited to, a keyboard, mouse, scanner, microphone, etc. Furthermore, the I/O devices may also include output devices, for example but not limited to, a printer, display, etc. Finally, the I/O devices may further include devices that communicate both inputs and outputs, for instance but not limited to, a modulator/demodulator (modem; for accessing another device, system, or network), a radio frequency (RF) or other transceiver, a telephonic interface, a bridge, a router, etc.

When the job setting retention system 25 is implemented in software, as is shown in FIG. 2, it should be noted that the job setting retention system 25 can be stored on any computer-readable medium for use by or in connection with any computer related system or method. The job setting retention system 25 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device. The computer-readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

In an alternative embodiment, where the job setting retention system 25 is implemented in hardware, the job setting retention system 25 can be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

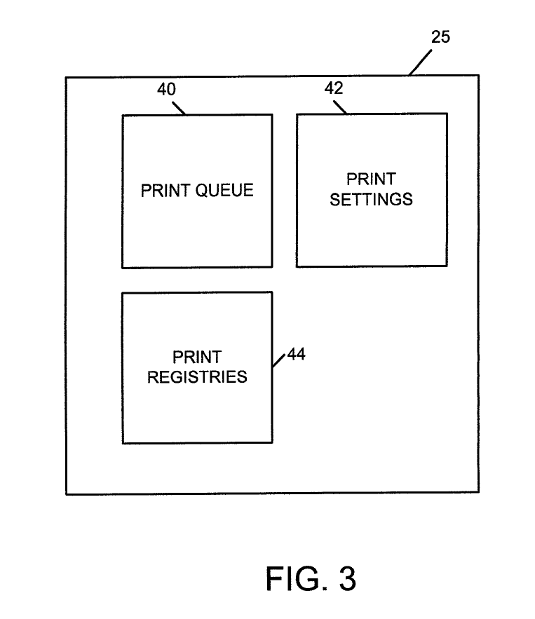

FIG. 3 is a block diagram depicting an embodiment of modules of the job setting retention system 25 of FIG. 2. The job setting retention system 25 includes a print queue 40, print settings 42, and registries 44 (only one of each is shown for simplicity). The print queue 40 is a storage facility that takes bit streams of print job requests from a plurality of devices 12, 14, 16, 18, and 19, including remotely connected printers, and releases them to the imaging device 20 at a rate that the imaging device 20 can handle. Print settings 42 store the printer specific settings, such as, fonts, default tray, and available memory.

The registry 44 is a tree-structured database containing names of data formats (also referred to as data types), options for each data format, and values associated with each option. Examples of data formats are joint photographic experts group (JPEG), tagged image file format (TIFF), Microsoft® Word documents, computer aided design (CAD) drawing files, and hypertext markup language (HTML) files. Example options may be media, draft mode, and resolution. A value can include, for instance, media type and size, such as letter size paper or transparency, and print finishing options, such as, duplex printing and stapling.

In one embodiment, the registry 44 is stored on an internal hard disk of the imaging device 20 or computing device 12. In an alternative embodiment, the registry 44 is stored in CompactFlash, RAM, and/or ROM memory. In yet another embodiment, the registry 44 is loaded into memory of the imaging device 20 upon initialization. In still another alternative embodiment (not shown), the registries 44 exist in a central repository on a remote machine that allows a number of printers 20 or other imaging devices to share the same registries 44. In yet another embodiment using networked printers (not shown), the registry 44 is stored on an internal server located behind a firewall that is retrievable by the imaging device 20 from the server. A setting registry may be established with user accounts to allow retention of individual settings per data format in a common registry 44.

The registry 44 provides for accessing the name/value pairs (e.g., in a memory block or a file) by programs. One registry 44 can store the unique job settings for as many data formats as a user defines. Further, the job settings may be imaging related or they may be device-specific. Whenever a given data format enters the print queue 40 of an imaging device 20, the corresponding print setting information stored in the registry 44 overrides any default print settings and is used to print the print job. Likewise, any specific print settings that accompany the print job will also override the settings in the registry 44 and are used to print the print job.

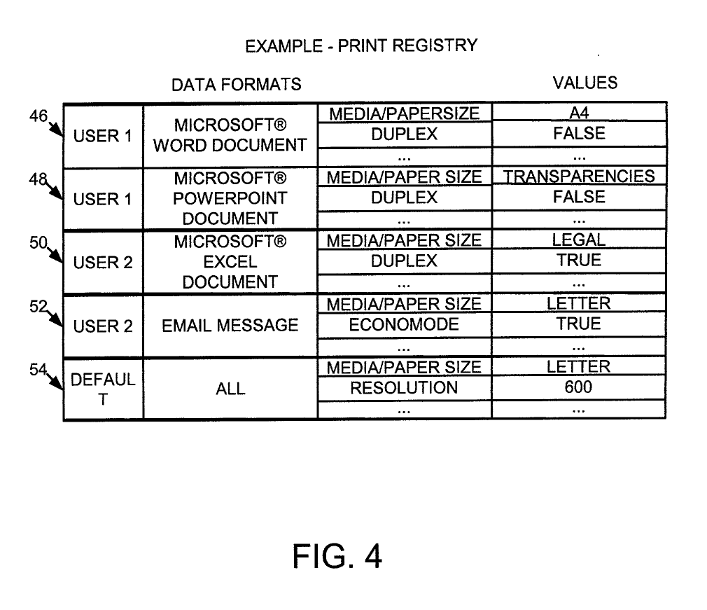

FIG. 4 is a table depicting an embodiment of the print registry 44 shown in FIG. 3. The table includes several rows that correspond to name (also referred to as a data format or data type)/value pairs of print job preferences for several users. For example, in row 46 of the registry 44, User 1 has established that word processing documents, such as Microsoft® Word, print on paper size A4 and duplex=false. These settings ensure that User 1 will print Word documents on A4 paper in a simplex mode, that is, print on one side of the paper. In row 48 of the registry 44, User 1 also prints presentations using Microsoft® PowerPoint. User 1 has set these documents to print on transparencies with duplex=false, such that only one side of each transparency is printed.

In row 50 of the registry 44, User 2 has established that Microsoft® Excel documents will print on legal size paper and has set duplex=true so that the imaging device 20 will print on both sides of the legal size paper. In row 52 of the registry 44, User 2 has established that his email messages will be printed on letter size paper and in draft mode, such as economode printing. Printing in economode causes the imaging device 20 to print pages using less toner.

In row 54 of the registry 44, the system administrator has established a default printing mode. The default mode can arise in a number of situations. For instance, if a user does not specify print settings in the registry 44, or if the imaging device 20 receives print settings unknown to the imaging device 20, or when it is necessary to override existing print setting established in the registry 44. The default mode will print all data formats on letter size paper with a 600 resolution, i.e., the standard resolution for the imaging device 20.

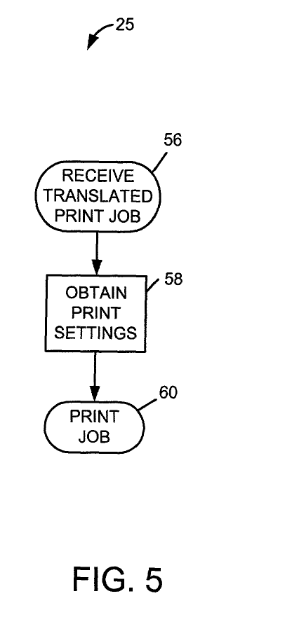

FIG. 5 is a flow chart depicting functionality of an embodiment of the job setting retention system 25 of FIG. 2. At 56, the imaging device receives a translated print job request. Translation involves converting a print file format to one that the particular imaging device involved can use to print the print job. At 58, the imaging device obtains the print job settings for printing that job type. Print job settings may reside on a registry of the local imaging device, a networked imaging device or a computing device. The imaging device is configured to retrieve the print job setting from the respective device. Print job settings can also include user specified settings and default job settings. At 60, the imaging device prints the print job using the print job settings retrieved from the registry.

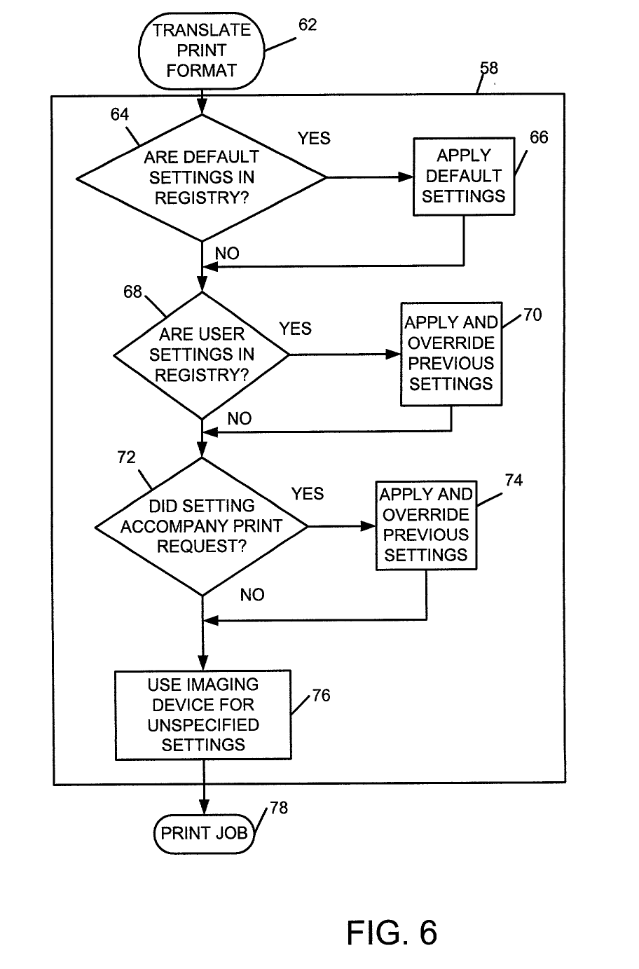

FIG. 6 is a flow chart depicting an embodiment of the step of obtaining the print job settings of the method of FIG. 5. At 62, the print format is translated by a translator and sent to the imaging device, for instance, a printer. A plurality of file formats can be sent to an imaging device. Examples of file formats include word processing documents, spreadsheets, presentations and electronic mail. The imaging device translates the received file format into one that the imaging device's print drivers can interpret, typically PCL® and PostScript® formats.

At 64, a check is performed to determine if default settings are in the registry. In one embodiment, default settings include settings established by a system administrator. The default settings are used if a job is received without print job settings or if the imaging device is unable to interpret the print job settings. In another embodiment, default settings of imaging device are utilized.

If default settings are in the registry, at 66, the default settings are applied. If no default settings reside in the registry, at 68, a check is performed to determine if the user has established settings in the registry. The user's settings include the values for file formats selected by the user. Settings can include the file format, paper size, and printing instructions. If yes, at 70, the user's settings are applied to the print job and the previous job settings, i.e., the default settings, are overridden.

If the user has not established his preferences in the registry, at 72, a check is performed to determine if a job specific setting accompanied the print request. If yes, at 74, the specific job settings are applied and any previous job settings are overridden.

If the user has not established his preferences in the registry, at 76, an unspecified condition exists. A risk exists that the imaging device cannot perform a given settings request. This case can be handled as follows. In one embodiment, if the imaging device cannot perform the function identified in the registry, it ignores that job setting. In most cases, this will probably suffice, but in certain situations this solution will not be sufficient. In an alternative embodiment, a query of the imaging device is performed to determine its capabilities and construct the job accordingly. For instance, an imaging device can exist that generates an extensible markup language (XML) document, which describes the print job down to the device settings, for example, stapling and duplexing. An associated job-generator that knows the capabilities of the imaging device will remove any settings, which are contradictory or physically impossible to print. The query can be made in several ways. First, the imaging device can be asked directly about its capabilities. As in step 76, the imaging device can utilize its own internal defaults, for instance, print using tray 1 instead of tray 2, print only one copy, or print in normal mode instead of draft mode. Imaging device defaults can be established by a user or an administrator through a control panel on the imaging device or via network software, such as JetAdmin or WebJetAdmin.

Second, a registry devoted to imaging devices and their capabilities can be maintained. This registry can be updated manually or dynamically through a connection established by each imaging device, for instance, at power-up and when its capabilities change.

At 78, the imaging device prints the job.

Any process descriptions or blocks in flow charts may be performed by modules, segments, logic or portions of code which include one or more executable instructions for implementing specific logical functions or steps in the process, and alternate implementations are included within the scope of the preferred embodiment of the present invention in which functions may be executed out of order from that shown or discussed, including substantially concurrently or in reverse order, depending on the functionality involved, as would be understood by those reasonably skilled in the art of the present invention.

In operation, the retention of job setting system obtains from the registry the user's preferred print setting based upon the file format received and prints the job using the user's preferred settings. For instance, a user may want to print Microsoft® Word Document files in duplex mode and Microsoft® PowerPoint files on transparencies in simplex mode. A second user may typically print Microsoft® PowerPoint files with two pages per sheet of paper to use as handouts. By use of this invention, each user has the ability to store his or her own settings for Microsoft® PowerPoint and Microsoft® Word files in the registry. The printer will use the correct settings for each user.

This invention allows imaging devices to retain print settings so users that frequently print the same data formats have the ability to specify how each class of print job is to be printed and these settings will be recalled automatically by the imaging device. Further, the desired printer settings are associated with the data format instead of the print driver language, e.g., PCL® and PostScript®.

It should be emphasized that the above-described embodiments of the present invention, are examples of implementations, set forth for a clear understanding of the principles of the invention. Many variations and modifications may be made to the above-described embodiment(s) of the invention without departing from the spirit and principles of the invention. All such modifications and variations are intended to be included herein within the scope of this disclosure and the present invention and protected by the following claims.

What is claimed is:

1. A system for printing based upon a user's preference, comprising:
a processor adapted to communicate with an imaging device; and
a registry accessible to the processor, the registry including print settings for printing an image based upon a data format and at least one user's preferred print setting.

2. The system of claim 1, wherein the data format is a JPEG file format, TIFF file format, word processing document, spreadsheet document, presentation file format, electronic mail document, CAD drawing file or HTML file.

3. The system of claim 1, further comprising a default print setting in the registry.

4. The system of claim 3, wherein the processor is configured to override the default print setting in the registry when the registry contains print setting information for the at least one user.

5. The system of claim 1, wherein the processor is configured to override the at least one user's preferred print setting in the registry when a specific print setting accompanies a print job.

6. The system of claim 1, wherein the registry further comprises print settings for the imaging device.

7. The system of claim 1, wherein the registry is stored in memory on the imaging device.

8. The system of claim 1, wherein the imaging device is a part of a computer network and the registry is stored on the processor or a server on the computer network.

9. The system of claim 1, wherein the registry further comprises a unique job print setting for at least one data format defined by the user.

10. The system of claim 1, wherein the at least one user's preferred print setting further comprises a data format and associated print settings.

11. The system of claim 1, wherein the registry is stored in a central repository on a machine remote from the imaging device.

12. The system of claim 1, wherein the imaging device further comprises a default print setting for use when there is no user print setting stored in the registry.

13. A system for printing based upon a user's preference, comprising:
means for processing a print request and sending that request to an imaging device; and
means for storing at least one user's preferred print settings.

14. The system of claim 13, further comprising means for accessing the means for storing the at least one user's preferred print settings upon receiving a print job request.

15. The system of claim 14, further comprising means for overriding the user's preferred print settings and applying a default print setting.

16. A method for printing based upon a user's preferences, comprising the steps of:
associating user print settings with a data format;
receiving a print request;
accessing the user print settings; and
printing the request according to the user print settings.

17. The method of claim 16, further comprising accessing default print settings and applying the default print setting,
accessing a print registry to determine whether the user print settings resides in the registry, and applying the user print settings when the user print settings reside in the registry and overriding any previous print settings.

18. The method of claim 16, further comprising determining whether a specific print setting accompanied a print request, applying the specific print setting, and overriding any previous print settings.

19. The method of claim 18, further comprising using settings of an imaging device for printing when print settings are unspecified.

20. The method of claim 16, further comprising printing the print job.

21. A computer-readable medium having a computer program for printing based upon a user's preferences, comprising:
logic configured to associate user print settings with a data format;
logic configured to receive a print request;
logic configured to access the user print settings; and
logic configured to print the request according to the user print settings.

22. The computer-readable medium of claim 21, further comprising logic configured to access default print settings and to apply the default print setting, logic configured to access a print registry to determine whether the user print settings reside in the registry, to apply the user print settings when the user print settings reside in the registry, and to override any previous print settings.

23. The computer-readable medium of claim 21, further comprising logic configured to determine whether a specific print setting accompanied a print request, to apply the specific print setting, and to override any previous print settings.

24. The computer-readable medium of claim 23, further comprising logic configured to use settings of an imaging device for printing when print settings are unspecified.

25. The computer-readable medium of claim 21, further comprising logic configured to print the print job.
